(19) United States
(12) Patent Application Publication
(10) Pub. No.: US 2004/0052697 A1
(43) Pub. Date: Mar. 18, 2004

(54) Catalytic converter

(76) Inventors: Loel E. McIntosh, Grand Blanc, MI (US); John C. Boehnke, Grand Blanc, MI (US); James T. Harris, Metamora, MI (US); Harry G. Hofbauer, Waterford, WI (US); William A. Schmidt, Clio, MI (US)

Correspondence Address: VINCENT A. CICHOSZ, DELPHI TECHNOLOGIES, INC., Legal Staff, Mail Code: 480-410-202, P.O. Box 5052, Troy, MI, 48007-5052, US

(21) Appl. No.: 10/246,376

(22) Filed: Sep. 18, 2002

(51) Int. Cl. B01D 53/34

(52) U.S. Cl. 422/179; 422/177; 422/180; 29/890

(57) ABSTRACT

The catalytic converter comprises a shell having a curled edge. When assembling the catalytic converter, the curled edge is inserted into the mat support material of the mat support material/catalyst substrate subassembly disposed in the shell. Once inserted, the curled edge and mat support material form an airgap that can thermally insulate and mechanically isolate the mat support material.

### TECHNICAL FIELD

The invention relates to catalytic converters for mobile vehicles and, more particularly, to an apparatus and method for reducing the thermal deterioration of a mat support material for a catalyst substrate in a catalytic converter.

### BACKGROUND OF THE INVENTION

Catalytic converters are universally employed for oxidation of carbon monoxide and hydrocarbons and reduction of the oxides of nitrogen in automobile exhaust gas streams. A catalyst substrate comprising a catalyst, disposed within the shell of the catalytic converter, facilitates the oxidation and reduction process of the exhaust gas stream. Catalyst substrates tend to be frangible and have coefficients of thermal expansion differing markedly from their metal, usually stainless steel, shells. As a result, the mounting means of the substrate, typically a mat support material disposed between the catalyst substrate and the shell, must provide resistance to mechanical shock due to impacts and vibrations and to thermal shock due to thermal cycling. Both thermal and mechanical shock may cause deterioration of the mat support material, which once started, quickly accelerates and ultimately renders the device useless.

Intumescent and non-intumescent sheet mat support materials do an adequate job of holding the substrate in place while resisting erosion at moderate exhaust temperatures, and moderate pressure pulsations of the exhaust gas. However, when positioning the catalytic converter closer to the engine exhaust manifold, the converter, including the mat support materials are subjected to much higher exhaust temperatures. Under these conditions, over a period of time, existing mat support materials can be eroded.

Some catalytic converter designs, and especially designs without inner end cones, incorporate an edge protection material around the intake area of the catalyst substrate to reduce mat erosion and thermal deterioration of the mat support material. In one application, a stainless steel wire mesh fabric or screen, as described in U.S. Pat. No. 5,008,086 to Merry, is disposed concentrically about the exhaust gas inlet of a catalytic converter. Another application discloses adhering a braided or rope like ceramic fiber in combination with a metal wire material, as described in U.S. Pat. No. 5,449,500 to Zettel, around the exhaust gas inlet of a catalytic converter. Edge protectors can also be formed from compositions having glass particles, such as a glass filled strip material, as described in EP 639 701 A1 and EP 639 702 A1 to Howorth, and EP 639 700 A1 to Stroom. Additionally, at least one catalytic converter, as described in U.S. Pat. No. 5,882,608 to Sanocki, employs a mat support material comprising non-intumescent inserts to reduce mat erosion and thermal deterioration of the mat support material. Incorporating edge protection materials while assembling a catalytic converter, however, requires additional labor to incorporate such components into the assembly process. In addition, edge protection materials increase the overall weight of the catalytic converter. This, in turn, ultimately reduces the likelihood of meeting the customer's packaging constraint requirements.

Consequently, there is a need for an apparatus and method for reducing mat erosion and thermal deterioration of the mat support material in a catalytic converter.

### SUMMARY OF THE INVENTION

The drawbacks and disadvantages of the prior art are overcome by the catalytic converter of the invention disclosed herein and its method of manufacture. The catalytic converter comprises; a catalyst substrate comprising a catalyst; a shell having a curled edge and an opening, concentrically disposed around said catalyst substrate; a mat support material disposed concentrically around said catalyst substrate, between said catalyst substrate and said shell; and a cover disposed around said opening.

The method manufacturing a catalytic converter of the present invention comprises: forming a catalyst substrate comprising a catalyst; disposing a mat support material concentrically around said catalyst substrate to form a subassembly; disposing said subassembly concentrically within a shell having an opening and a curled edge; and disposing a cover around said opening.

These and other features and advantages of the present invention will be apparent from the following brief description of the drawings, detailed description, and appended claims and drawings.

### BRIEF DESCRIPTION OF THE DRAWINGS

For a further understanding of the nature of the present invention, as well as other features and advantages thereof, reference should be made to the following detailed description taken in conjunction with the accompanying drawings, which are meant to be exemplary, not limiting, and wherein like elements are numbered alike in the several figures.

FIG. 1 is a partial cross-sectional view of an exemplary catalytic converter design of the present invention constructed using a shell having a curled edge inserted into the mat support material to reduce mat erosion and thermal deterioration of a mat support material from an exhaust gas stream;

FIG. 2 is an enlarged perspective of area 2-2 of FIG. 1 depicting in greater detail one embodiment of the curled edge of the present invention inserted into the mat support material;

FIG. 3 is a partial cross-sectional view of another exemplary catalytic converter design of the present invention constructed using a shell having a curled edge and a hollow cavity to reduce mat erosion and thermal deterioration of a mat support material from an exhaust gas stream; and

FIG. 4 is an enlarged perspective of area 4-4 of FIG. 3 depicting in greater detail one embodiment of the curled edge and hollow cavity of the present invention.

### DETAILED DESCRIPTION OF THE INVENTION

The catalytic converter comprises a catalyst substrate comprising a catalyst. The catalyst substrate can be disposed concentrically within a shell. A mat support material can be disposed concentrically between the catalyst substrate and shell, and around the catalyst substrate. The shell can include an opening and a curled edge. The curled edge can include a convex curvature that curves inward toward the mat support material until forming an edge. The curled edge, which can be inserted into the mat support material to form a thermally insulating airgap, can prevent an exhaust gas stream from directly impinging upon the mat support material. The curled edge can also be attached to the inner surface of the shell to form a hollow cavity. The curled edge attached to the shell and the hollow cavity can also prevent an exhaust gas stream from directly impinging upon the mat support material. As a result, the curled edge can reduce the mat erosion and thermal deterioration of the mat support material during operation of the catalytic converter.

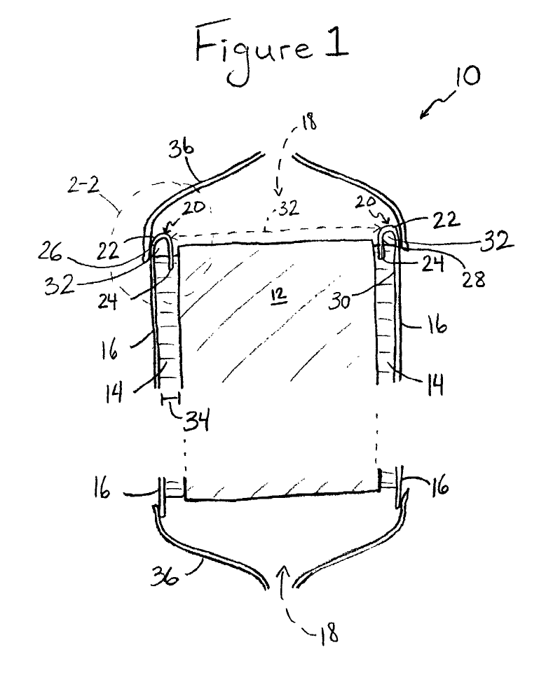

FIG. 1 depicts a partial cross-sectional view of a catalytic converter 10, which can reduce the thermal deterioration of the mat support material contained therein by an exhaust gas stream. Catalytic converter 10 catalytically treats the exhaust gas stream using a catalyst supported on a catalyst substrate 12.

Catalyst substrate 12 can comprise any material designed for use in a spark ignition or diesel engine environment, and having the following characteristics: (1) capable of operating at temperatures up to about 1,000° C., (2) capable of withstanding exposure to hydrocarbons, nitrogen oxides, carbon monoxide, carbon dioxide, and/or sulfur; and (3) having sufficient surface area and structural integrity to support material the desired catalyst. Some possible materials include cordierite, silicon carbide, metallic foils, alumina sponges, porous glasses, and the like, and mixtures comprising at least one of the foregoing. Some ceramic materials include “Honey Ceram”, commercially available from NGK-Locke, Inc, Southfield, Mich., and “Celcor”, commercially available from Corning, Inc., Corning, N.Y.

Although catalyst substrate 12 can have any size or geometry, the size and geometry are preferably chosen to optimize the surface area in the given converter design parameters. Typically, catalyst substrate 12 has a honeycomb geometry, with the combs being any multi-sided or rounded shape, with substantially square, hexagonal, octagonal or similar geometries preferred due to ease of manufacturing and increased surface area.

Disposed on and/or throughout catalyst substrate 12 is a catalyst for converting exhaust gasses to acceptable emissions levels as is known in the art. The catalyst may comprise one or more catalyst materials that are wash coated, imbibed, impregnated, physisorbed, chemisorbed, precipitated, or otherwise applied to the catalyst substrate. Possible catalyst materials include noble metals, such as platinum, palladium, rhodium, iridium, osmium and ruthenium; other metals, such as tantalum, zirconium, yttrium, cerium, nickel, copper and the like; metal oxides; and alloys and mixtures comprising of at least one of the foregoing, and other conventional catalysts.

Located in between catalyst substrate 12 and a catalytic converter shell 16 is a mat support material 14 that insulates shell 16 from both the high exhaust gas temperatures and the exothermic catalytic reaction occurring within catalyst substrate 12. Mat support material 14 further enhances the structural integrity of catalyst substrate 12 by applying compressive radial forces about it, reducing its axial movement, and retaining it in place. Mat support material 14 can either be a simple non-intumescent material, or an intumescent material, e.g., one which contains a vermiculite component that expands with heating to maintain firm uniform compression when the shell expands outward from the catalyst substrate, as well as materials which include a combination of both. Typical non-intumescent materials include ceramic materials, and other conventional materials such as an organic binder and the like, or combinations comprising at least one of the foregoing, such as those sold under the trademarks “NEXTEL” and “SAFFIL” by the “3M” Company, Minneapolis, Minn., or those sold under the trademark, “FIBERFRAX” and “CC-MAX” by the Unifrax Co., Niagara Falls, N.Y., and the like. Some intumescent materials include ceramic materials, vermiculite, or combinations comprising at least one of the foregoing, and other conventional materials such as organic binder and the like, such as those sold under the trademark “INTERAM” by the “3M” Company, Minneapolis, Minn., as well as those intumescents which are also sold under the aforementioned “FIBERFRAX” trademark, as well as combinations thereof and others.

The mat support material/catalyst substrate subassembly can preferably be inserted into shell 16. Shell 16 includes at least one opening for receiving the mat support material/catalyst substrate subassembly. The choice of material for shell 16 depends upon the type of exhaust gas, the maximum temperature reached by catalyst substrate 12, the maximum temperature of the exhaust gas stream, and the like. Suitable materials for shell 16 can comprise any material that is capable of resisting under-car salt, temperature and corrosion. Typically, ferrous materials are employed such as ferritic stainless steels. Some ferritic stainless steels include grades from the 400—Series such as SS-409, SS-439, and SS-441, with grade SS-409 generally preferred.

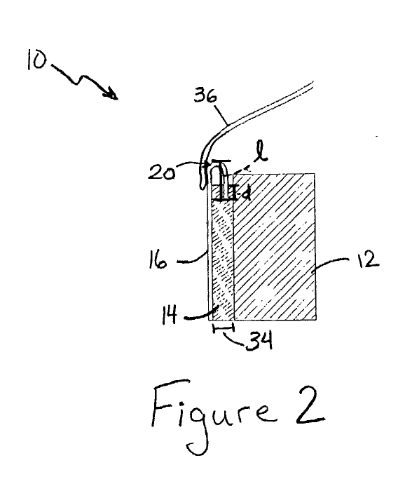

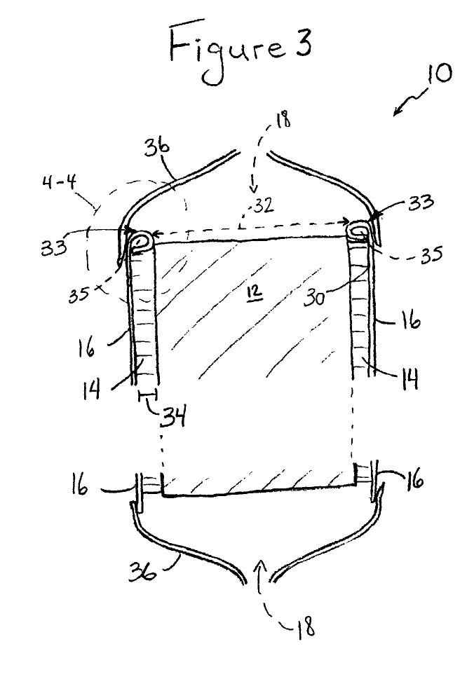

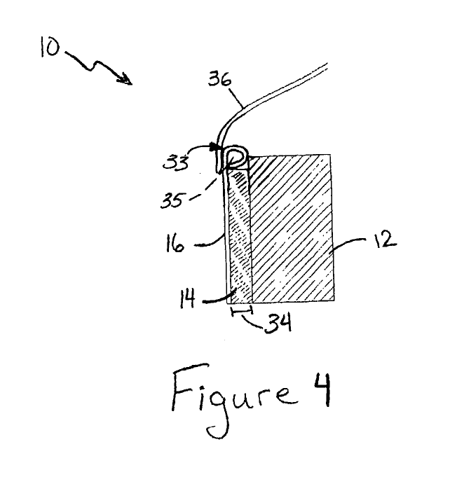

Referring now to FIGS. 1 and 2, shell 16 can include a curled edge 20 disposed at the inlet and/or outlet end of the shell 16. Curled edge 20 can be configured to form a convex curvature 22 that curves inward from an outer surface 26 of shell 16 toward mat support material 14, and forms an end 24. In one embodiment, both end 24 and an inner surface 28 of curled edge 20 do not contact an inner surface 30 of shell 16. As a result, a space forms between an inner surface 28 of curled edge 20 and inner surface 30 of shell 16. Alternatively, curled edge 20 can be attached to inner surface 30 of shell 16 to create a curled edge 33 having a hollow cavity 35 (see FIGS. 3-4). Curled edge 33 and hollow cavity 35 are both located within an annulus 34 of shell 16 of catalytic converter 10.

Typically, the mat support material/substrate subassembly can be inserted into shell 16 using a variety of methods. For example, the subassembly can be placed in a stuffing cone. The stuffing cone is a device that compresses mat support material 14 concentrically about catalyst substrate 12 using a ramming component. The ramming component stuffs the compressed mat support material/catalyst substrate subassembly into shell 16 without peeling mat support material 14 away from catalyst substrate 12. Shell 16 can be compressively closed upon the mat support material/catalyst substrate subassembly by exerting a substantially uniform compressive stress to complete the assembly of catalytic converter 10. In the alternative, a compressive sizing operation can be employed when the mat support material/catalyst substrate subassembly is disposed concentrically within shell 16. Shell 16 can be compressively sized to achieve the desired mat pressure of mat support material 14 to be exerted upon catalyst substrate 12.

Once substrate 12 is concentrically disposed within shell 16 by the stuffing cone or other alternative method(s), at least one outer endcone 36, or other suitable cover or material, can be welded to shell 16 to provide a gas tight seal around at least one opening 18. When the mat support material/catalyst substrate subassembly is concentrically disposed within shell 16, the end 24 of curled edge 20 can be inserted into mat support material 14. When inserted into mat support material 14, end 24 can increase the local density of mat support material 14, which, in turn, enhances the mat support material's resistance to deterioration and erosion. End 24 can be inserted into mat support material 14 a specified distance indicated by the letter “d” in FIG. 2. Generally, distance “d” can equal 10% to about 50% of the length of curled edge 20 indicated by the letter “l”. More specifically, distance “d” can preferably equal about 15% to about 25% of the length “l”. The space now becomes an airgap 32. Airgap 32 can be located within an annulus 34 of the catalytic converter assembly. Airgap 32 keeps the edge of mat support material 14 that is near the exhaust gas inlet somewhat cooler which helps minimize mat erosion and thermal deterioration of mat support material 14. In an alternative embodiment, the end of the curled edge 33 does not extend into the mat support material 14, it curls around to form cavity 35. Curled edge 33 deflects an exhaust gas stream from directly impinging upon mat support material 14, while cavity 35 provides additional thermal insulation. (See FIGS. 3 and 4). However, both airgap 32 and cavity 35 prevent direct conduction of heat from the exhaust stream to the mat support material 14.

Generally, when an exhaust gas stream flows into a typical catalytic converter, the exhaust gas stream enters the catalyst substrate and directly impinges upon the mat support material. The high exhaust gas temperature naturally elevates the mat support material's temperature due to this interaction. Additionally, some types of mat support material expand and insulate the catalyst substrate as the catalyst substrate reaches high temperatures of approximately 1000° C. while catalyzing the exhaust gas streams. However, in the instant application, both curled edge 20 and curled edge 33 prevent direct impingement of hot exhaust gas and the pressure pulse of each engine cylinder discharge. Airgap 32 and cavity 35 prevent direct conduction of heat from the exhaust gas stream to the mat support material..

The exemplary embodiment of the invention provides several advantages over current catalytic converter designs. First, the curled edge disclosed herein protects the mat support material from direct impingement of hot exhaust gas and pressure pulses from each engine cylinder discharge. The curled edge provides a more efficient and cost effective method for insulating the shell of the catalytic converter because the airgap prevents direct conduction of heat from the exhaust gas stream to the mat support material, there is less heat transferred from the mat support material to the metallic shell. The non-intumescent/intumescent mounting systems disclosed in Sanocki et al., for example, solely focus upon lessening the deformation of the shell without adequately addressing the cause of deformation stemming from the high temperature conditions. Furthermore, and unlike the curled edge disclosed herein, these non-intumescent/intumescent mounting systems disclosed in Sanocki et al. are costly to manufacture given the additional time, labor, and materials required to assemble and manufacture just one.

Second, the curled edge disclosed herein can protect against mat erosion and thermal deterioration using a minimum number of components. Unlike the combination of inserts and edge protection materials described in Sanocki, et al., the exemplary embodiments disclosed herein employ a minimum number of additional components. The shell is manufactured to incorporate a curled edge, which along with the mat support material forms a thermally insulating airgap. The insertion of the curled edge into the mat support material alone can reduce mat erosion and thermal deterioration of the mat support material during operation of the catalytic converter.

Third, modifying a shell is more efficient and, in the end, more cost effective and beneficial to consumers than encumbering the typical manufacturing process with additional steps and components. Additionally, modifying the shell to incorporate a curled edge does not compromise customer packaging constraint requirements. Packaging constraints take into consideration placement of the part within the automotive vehicle as well as the part's weight, location, and size.

Fourth, catalytic converters are now more commonly manufactured with multiple catalyst substrates, which are wrapped in mat support material. After the subassembly is stuffed into the shell, one can easily confuse the exhaust gas inlet and exhaust gas outlet of the multiple catalyst substrates due to the lack of distinguishing features on the shell. The curled edge enables facile identification of the inlet and outlet.

Finally, the curled edge also significantly stiffens the shell profile. Typically, a shell profile deforms when the mat support material/catalyst substrate subassembly is stuffed into the shell. The deformation normally creates non-uniform mat support material density in non-round catalytic converter designs. Stiffening the shell profile actually reduces shell deformation resulting from the stuffing process, thereby improving the uniformity of the mat support material density and the ability of the mat support material to protect the catalyst substrate and insulate the shell.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A catalytic converter, comprising:
a catalyst substrate comprising a catalyst;
a shell having a curled edge and an opening, and said shell concentrically disposed around said catalyst substrate;
a mat support material disposed concentrically around said catalyst substrate, between said catalyst substrate and said shell; and
a cover disposed around said opening.

2. A catalytic converter recited in claim 1, wherein said curled edge includes a convex curvature curved inward from an outer surface of said shell toward said mat support material until forming an end.

3. A catalytic converter recited in claim 2, wherein said end is inserted into said mat support material.

4. A catalytic converter recited in claim 3, wherein said end is inserted into said mat support material a distance of about 10% to about 50% of the length of said curled edge.

5. A catalytic converter recited in claim 4, wherein said end is inserted into said mat support material a distance of about 15% to about 25% of the length of said curled edge.

6. A catalytic converter recited in claim 3, wherein said curled edge and said mat support material define an airgap.

7. A catalytic converter recited in claim 2, wherein said end is attached to an inner surface of said shell.

8. A catalytic converter recited in claim 7, wherein said end forms a hollow cavity.

9. A catalytic converter recited in claim 1, wherein said cover provides a gas tight seal.

10. A method for manufacturing a catalytic converter, comprising:
forming a catalyst substrate comprising a catalyst;
disposing a mat support material concentrically around said catalyst substrate to form a subassembly;
disposing said subassembly concentrically within a shell having an opening and a curled edge; and
disposing a cover around said opening.

11. A method recited in claim 10, further comprising inserting said curled edge into said mat support material to form an airgap.

12. A method recited in claim 10, further comprising forming a gas tight seal with said cover.

13. A method recited in claim 10, further comprising disposing compressively said mat support material around said catalyst substrate using a stuffing method.

14. A method recited in claim 10, further comprising compressively sizing said shell about said subassembly.

15. A method recited in claim 10, further comprising attaching said curled edge to an inner surface of said shell to form a hollow cavity.
